(19) United States
(12) Patent Application Publication
(10) Pub. No.: US 2026/0100839 A1
(43) Pub. Date: Apr. 9, 2026

(54) ZERO-KNOWLEDGE AUTHENTICATOR - POLICY-PRIVATE AND OBLIVIOUSLY UPDATEABLE

(71) Applicant: Mysten Labs, Inc., Palo Alto, CA (US)

(72) Inventors: Konstantinos Chalkias, Dubai (AE); Arnab Roy, Fremont, CA (US); Sai Krishna Deepak Maram, Jersey City, NJ (US); Joy Wang, Brooklyn, NY (US); Aayush Yadav, McLean, VA (US)

(73) Assignee: Mysten Labs, Inc., Palo Alto, CA (US)

(21) Appl. No.: 19/352,158

(22) Filed: Oct. 7, 2025

Related U.S. Application Data
(60) Provisional application No. 63/704,381, filed on Oct. 7, 2024.

(51) Int. Cl. H04L 9/32; H04L 9/08; H04L 9/40

(52) U.S. Cl. CPC H04L 9/3221; H04L 9/0866; H04L 9/0891; H04L 9/40

(57) ABSTRACT

The present technology can allow a user to use a zero-knowledge authenticator (zkAt) to login to an account while preserving privacy of the authentication policy. More specifically, the present technology describes several implementations of a zkAt to enable policy-private authentication and to enable oblivious updates to authentication policies. The zkAt can be, for example, a zero-knowledge proof system where the underlying relation in the policy predicate remains private.

### CROSS-REFERENCE TO RELATED APPLICATIONS

This application claims priority to U.S. Provisional Application 63/704,381 filed on Oct. 7, 2024, and titled “Zero-Knowledge Authenticator-Policy-Private and Obliviously Updateable,” the entire contents of which is incorporated herein by reference.

### BACKGROUND

Blockchain technology can offer a transparent and immutable ledger of transactions, which fosters trust among participants without the need for centralized intermediaries. However, this transparency can come at the cost of privacy, with transaction details, participant identities, and contract logic being exposed on most blockchains.

Public account authentication logic can be a point of vulnerability on a blockchain. For example, revealing authentication logic on a blockchain can make it easier for malicious actors to design targeted attacks by deriving knowledge from the authentication logic. For example, a malicious actor could determine information about an organization's structure from transaction information revealing the participating signers or the weights and thresholds for the multisig wallet setup. In another example, a malicious actor could determine which platform was used to log in, which further enables the malicious actor to develop targeted attacks.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates some concepts behind a zero-knowledge proof in accordance with some aspects of the present technology.

FIG. 2 illustrates an example system for authenticating a user account using a zero-knowledge proof authenticator, in accordance with some aspects of the present technology.

FIG. 3 illustrates an example routine for authenticating a user account using a zero-knowledge proof authenticator in accordance with some aspects of the present technology.

FIG. 4 shows an example of a system for implementing certain aspects of the present technology.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As discussed briefly above, blockchain technology offers a transparent and immutable ledger of transactions, fostering trust among participants without the need for centralized intermediaries. However, this transparency often comes at the cost of privacy, as transaction details, participant identities, and contract logic are exposed to public scrutiny on most blockchains. Accordingly, there is a need to address the problem of privacy for public account authentication logic. Revealing authentication logic on a blockchain can make it easier for malicious actors to design targeted attacks.

For example, the OAuth 2.0 standard allows users to use an existing account from one platform to authenticate on another. For a multisig account that is controlled by a large hierarchical organizations, every transaction signature reveals all the participating signers, and/or weights and threshold for the multisig wallet setup. This may leak organizational structure to potential attackers. Knowing which platform was used to log in, or even the fact that a given user employs web2 login (as opposed to a normal private key), might offer important information to an attacker. More generally, hiding authentication logic adds a layer of obfuscation complicating the efforts of attackers to compromise security measures.

In some cases, trusted hardware can be used to realize generic private authenticators. A private key can be stored in a trusted execution environment (TEE) and access to it can be predicated upon an arbitrarily-set authentication policy. Thanks to the confidentiality of TEEs, the policy will remain private. However, solutions using TEEs may have a number of weaknesses.

The present technology introduces privacy-preserving mechanisms that enable participants to authenticate transactions and fulfill on-chain conditions without revealing sensitive information or compromising the integrity and security of the blockchain. For example, the present technology introduces private authentication logic, which not only enhances user privacy on the blockchain, but also enables the use of more flexible privacy attributes.

In some examples, zero-knowledge proofs (ZKPs) can be applied to the systems and methods herein to provide succinct proof of the truth of an input without providing the input to a third party. This preserves privacy to the contents of the input, while also keeping the proof short (e.g., no exchange of the entire contents to the third party) and fast to verify. The application of ZKPs allows a third party/verifier to know that the input and/or a statement about the input is true while revealing nothing about why it is true.

In some examples, an authentication scheme can be used to implement ZKPs. For example, a zero-knowledge authenticator (zkAt) can be implemented in several variations. First, the zkAt can be implemented with guaranteed privacy for a user's secret credentials with respect to a non-trivial policy predicate. In this implementation, a ZKP system can be constructed in which the underlying relation in the policy predicate, and the privacy guarantee, is the zero-knowledge property. If the ZKP system has a designated-prover, then the corresponding proof verification key vk can be assigned as the user's public address.

In a second variation, the zkAt can be a policy-private zkAt (PP-zkAt), which provides secrecy of the underlying policy predicate itself. This can be formally modeled by a security experiment called vk-equivocation, where an adversary holding a proof verification key must identify which of the two policies of its choice was used to create an honest proof. Here, if the underlying proof system has equivocable verification keys, or in other words if it can have the same verification key for two different prover keys, then such a scheme must be policy-private. To develop such a proof system with vk-equivocation, a Groth 16 protocol can be used to describe a construction for constant-size non-interactive zero-knowledge argument of knowledge (NIZKAoK) for Quadratic Arithmetic Programs (QAPs) from pairing-based assumptions. The Groth16 protocol can be modified by redefining the key generation such that the verification key can be sampled independently of the relation. Thus, a zkAt scheme instantiated with such a proof system hides the underlying policy predicate since the verification key reveals no information about the policy itself, and the proof is zero-knowledge.

In a third variation, the zkAt can be an obliviously updateable PP-zkAt (OP-zkAt). In such examples, a trusted authority (such as the authority setting policies) can update the policy predicate without revealing any associated information about the update to the blockchain, including the fact that the policy was even updated. The latter requirement, that the update itself not be revealed to the blockchain, is what makes this problem non-trivial, as without this requirement, new keys could be issued each time a policy was updated with the use of additional primitives, for example, trapdoor commitments. This can be done with no change to the user's address. One solution is to instantiate the proof system with a universal circuit with the policy predicate as (private) input to the circuit. Unfortunately, this results in prohibitively expensive setup costs and is therefore an unsatisfactory approach in practice. Instead, in this third variation, NIZK proofs can be recursively composed with the “inner” proof corresponding to the policy predicate, and the “outer” proof to the knowledge of a valid proof to the policy predicate as well as a signature on the inner verification key for soundness. Thus, a verifier can verify the outer proof and is convinced of the user's authenticity. Moreover, when a new policy is created, the authority issues a fresh signature on the new inner verification key alongside it with no change to the outer keys so that the verifier is unaware of the change.

In the third implementation, a user holding an older proving key can still authenticate with respect to that policy. However, this vulnerability is addressed by having the authority additionally sign an expiration time that the user must prove is less than the current time, and has the benefit of allowing policies to expire gracefully.

Threshold signing and multi-signing are commonly used authentication mechanisms on the blockchain. The present technology, zkAt, offers the same benefits of threshold-based solutions such as privacy of signers, compact signatures while also capturing more complex policy semantics beyond the threshold, i.e., it allows one to make statements such as “Require two out of three signatures for transactions greater than amount X,” or “Users in list L must always require three out of three signatures,” as well as conjunction (and disjunction) of these statements. Moreover, with zkAt, this can be achieved with pre-existing signing keys and without requiring any expensive distributed key-generation, a pre-requisite for threshold signatures and PP-zkAt and OP-zkAt (the second and third variations listed above) push the privacy guarantees even further.

Another common authentication mechanism, attribute-based authentication, is based on user attributes satisfying certain pre-specified criteria This is essentially a policy-based authentication mechanism with the important distinction that the authentication policy need not be private. Put another way, one may view zkAt as an extension of attribute-based authentication that offers stronger privacy guarantees not just for the user's attributes, but also for the constraints on those attributes.

An interesting connection exists between the zkAt primitive, and functional commitment schemes that enable a user to succinctly commit to a function (from a specified family), such that the user can later verifiably reveal values of the function at desired inputs. For example, the user generates a proof that y=ƒ(x) for committed function ƒ and chosen value x. Such a commitment must be binding to the function and may additionally also hide it. Viewing through this lens, one can observe that zkAt generalizes a (binding) functional commitment scheme with vk being the commitment to the function defined by the policy predicate and PP-zkAt can similarly be viewed as a generalization of (hiding) functional commitment with a trapdoor. Assuming that the private inputs to the policy (equivalently the function) is ⊥, these primitives are essentially functional commitments. In some cases, OP-zkAt gives a functional commitment where the underlying function is updateable (given the trapdoor) without changing the commitment.

The present technology can improve security in several authentication applications. For example, the present technology facilitates the use of complex policy thresholds without undue increase in proof size or verification time. As another advantage, the present technology, by not revealing the underlying policy, can improve enterprise security by not revealing corporate policies or corporate structures.

The above is a description of some of the advantages of the present technology. Additional features and advantages will be addressed in more detail herein.

As used herein, the term “user” shall be considered to mean a user of an electronic device(s). Actions performed by a user in the context of computer software shall be considered to be actions taken by a user to provide an input to the electronic device(s) to cause the electronic device to perform the steps embodied in computer software. In some instances, a user can refer to a user account associated with a particular electronic device.

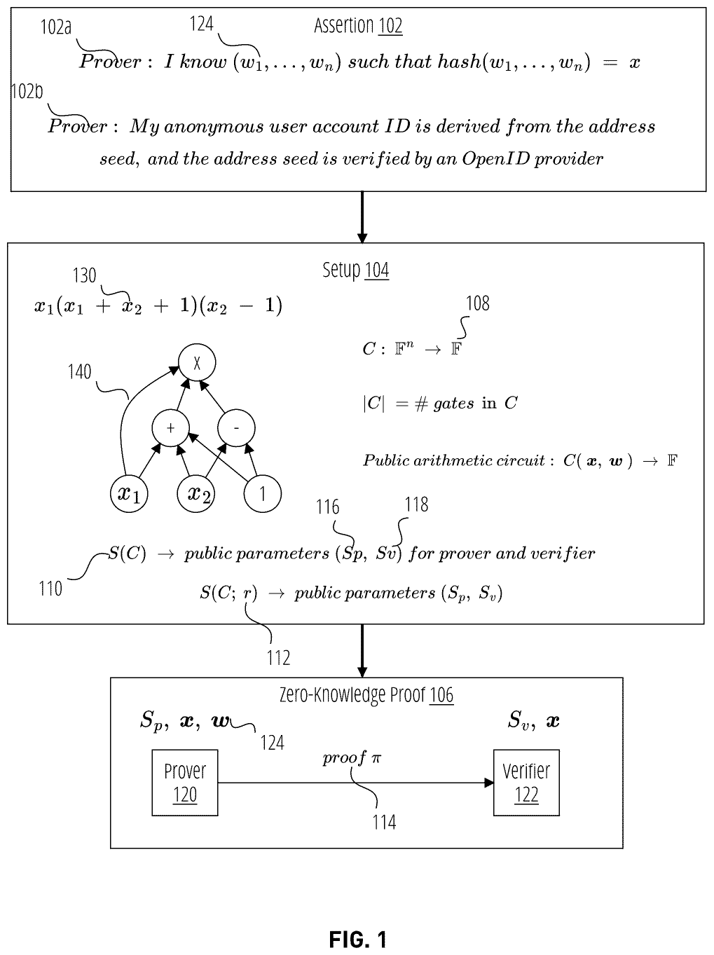

FIG. 1 illustrates some concepts behind a zero-knowledge proof in accordance with some aspects of the present technology.

Zero-knowledge proofs (ZKPs) are a cryptographic concept that allows one party, called the prover 120, to prove to another party, called the verifier 122, that a particular statement is true without revealing any additional information about the statement. In more detail, zero-knowledge proofs enable one party to run an arbitrary program 108 with secret inputs and then prove to another party that the program accepted the inputs as valid and was executed correctly without revealing anything about the secret inputs or the execution of the program. In FIG. 1, the statement or inputs are the assertion 102.

The assertion 102 illustrates a generic assertion 102a, which states that the prover 120 knows something, called a witness, such that the hash of that witness has a value x. This statement can be mathematically proved as will be explained below, such that the verifier can be nearly certain that the prover 120 is telling the truth. In the context of the present technology, the specific assertion 102b is that the anonymous user account ID is derived from an address seed that was verified by an OpenID provider.

There are many different variations of zero-knowledge proofs, but the present technology utilizes variations of zero-knowledge proofs that are non-interactive. Non-interactive refers to the property of the zero-knowledge proof that the prover 120 sends their argument in a common reference string 110, and a proof 114 of their argument to the verifier 122, and the verifier 122 can accept the argument without further interrogation of the prover 120. The non-interactive property helps the zero-knowledge proof be fast enough for many practical applications.

Another property of some zero-knowledge proofs is that they are succinct. In this context, this means that the proof 114 itself is succinct enough for an application to be able to calculate the proof efficiently. However, to obtain this property, the zero-knowledge proof needs a setup 104 as will be addressed further below.

One type of zero-knowledge proof that is useful in the context of the present technology is a zk-SNARKs (zero-knowledge succinct non-interactive arguments of knowledge). A zk-SNARK is a specific type of zero-knowledge proof that provides succinct and efficient proofs of knowledge.

The term “SNARK” stands for “Succinct Non-interactive ARgument of Knowledge.” Zk-SNARKs are designed to generate proofs 114 that are very short and require minimal computational resources to verify. The proof size is typically independent of the complexity of the statement being proven, which makes zk-SNARKs highly efficient.

In zk-SNARKs the “argument of knowledge” property allows the prover 120 to convince the verifier 122 not only that a statement is true, but also that the prover 120 possesses knowledge of the information necessary to prove the statement. This property ensures that the prover 120 cannot produce a valid proof without actually knowing the underlying secret (witness) or data.

Zk-SNARKs rely on advanced cryptographic techniques, specifically pairing-based elliptic curve cryptography and certain mathematical structures called bilinear maps. These techniques enable the generation of short proofs and efficient verification. In a zk-SNARK construction, the prover 120 first creates a so-called “circuit” 140 during a setup 104 that represents the computation they want to prove. The circuit 140 can be converted into a “quadratic arithmetic program 108” (QAP). A quadratic arithmetic program 108 represents a computation as a set of polynomial 130 equations. A feature of a polynomial is that for a given set of variables, it is still possible to solve the equation even if a variable is not known, assuming enough is known about the relationship of the unknown variable to the known variables.

Prover 120 constructs one or more polynomial equations that represent the computation it wants to prove that includes a witness 124, which is the knowledge that the prover 120 wants to prove without revealing the witness 124. Prover 120 constructs a zk-SNARK proof 114 using the witness 124 polynomial, the quadratic arithmetic program 108, and additional cryptographic operations. The proof is a succinct representation of its knowledge of the solution to the equations.

The zk-SNARK requires some setup 104 to generate the mathematical circuit and convert it into the quadratic arithmetic program 108. The setup 104 can be performed by the prover 120, or it can be performed by a trusted provider in what is known as a trusted setup. In order to provide the zero-knowledge aspect of the zero-knowledge proof a random value 112 can be combined with the witness 124 to ensure that the witness 124 can't be independently derived. The random value 112 can be used to compute common reference string 110 so that information that is public is further obfuscated. The common reference string 110 can include prover parameters 116 and verifier parameters 118. The random value 112 should be discarded at the end of the setup 104 to ensure that no party can either derive the witness 124 or impersonate the prover 120.

The setup may only be needed to be performed once between two parties. Thereafter, the prover 120 and verifier 122 can reuse the same parameters to generate a zero-knowledge proof 106 repeatedly.

While not shown in FIG. 1, the creation of the proof can be computationally expensive, but the verification of the proof is less complex.

Verifier 122 uses the common reference string 110 of the zk-SNARK scheme and the proof generated by prover 120 to verify its correctness. Verifier 122 can efficiently check if the proof is valid without learning anything about Prover's 120 secret value “w₁, . . . , wₙ.”

The argument of knowledge property ensures that prover 120 could not have generated a valid proof without knowing a value “w₁, . . . , wₙ” that satisfies the equations. If an attempt is made to forge a proof without possessing the necessary knowledge, the verification process would fail.

By using the quadratic arithmetic program 108 and cryptographic techniques, zk-SNARKs enables the prover 120 to convince the verifier 122 of knowledge about the underlying secret without explicitly revealing the secret itself. This property is crucial for preserving privacy and confidentiality while providing evidence of correctness. In some examples, for example, the properties related to the application of zk-SNARKs can be useful for public systems based on private information, such as blockchains and other similar verification systems.

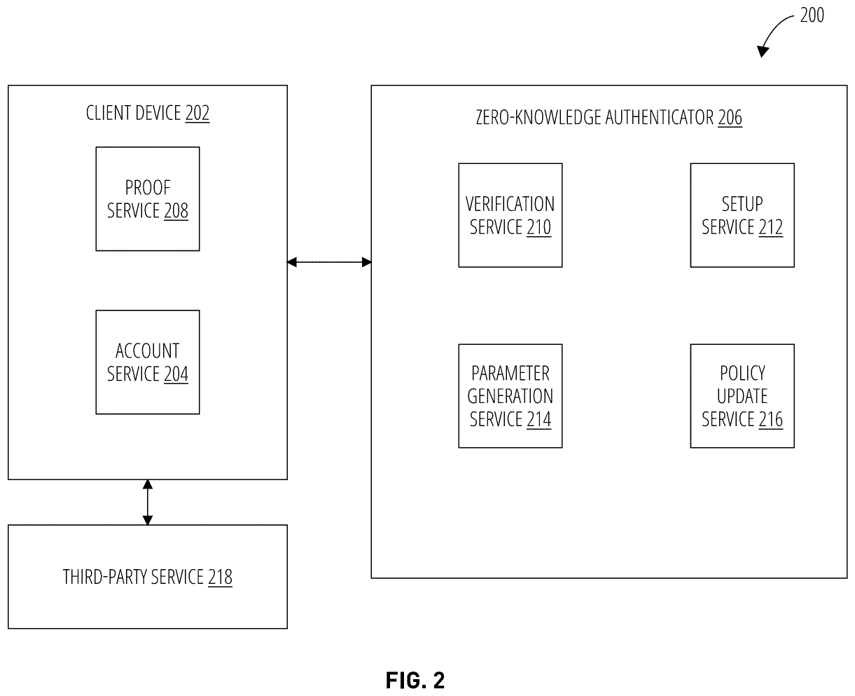

FIG. 2 illustrates an example system 200 for implementing a zero-knowledge authenticator in accordance with some aspects of the present technology.

System 200 may include a client device 202, a third-party service 218, and a zero-knowledge authenticator 206. In one example, a user operating client device 202 may wish to access an account hosted by third-party service 218. Third-party service 218 can be associated with an account service 204 (e.g., stored as an application on client device 202) that manages user accounts and relies on the zero-knowledge authenticator 206 to privately verify authentication. Client device 202 may include a proof service 208 to generate a zero-knowledge proof based on a secret proving key, a message, and auxiliary data. The proof service 208 stored on client device 202 ensures that the secret proving key does not need to be distributed outside client device 202.

In some examples, account service 204 can be a wallet provider being used to conduct transactions on a blockchain (e.g., third-party service 218) where the transactions on the blockchain are intended to occur without putting any of the user's Personal Identifiable Information (PII) on the blockchain. In another example, account service 204 can be a credential manager that stores one or more unique usernames (e.g., anonymous user account IDs). In another example, account service 204 could be any provider that providing anonymous user account IDs in the hosting of their own service.

Zero-knowledge authenticator 206 may include several functional services. A verification service 210 may verify the zero-knowledge proof against a public verification key, the message, and the auxiliary data to confirm authenticity of the account or attributes of the account. A setup service 212 may receive a security parameter and a policy, and to generate a public verification key, a secret proving key, and a secret trapdoor. A parameter generation service 214 may produce global and private parameters for use by the zero-knowledge authenticator, such as when enabling disjunctive policy updates. A policy update service 216 may perform updates to the authentication policy, for example by generating updated proving keys and trapdoors while leaving the verification key unchanged, thereby preserving policy privacy and enabling oblivious policy updates. In some examples, setup service 212 may be stored by client device 202.

To initiate the verification process, client device 202 provides an access request to account service 204. The access request may include a message, auxiliary data, and a secret proving key associated with the user account. For example, the message may correspond to a request to authorize a blockchain transaction, log into an application, or unlock access to restricted data.

Upon receiving the request, account service 204 communicates with proof service 208 which generates a zero-knowledge proof demonstrating that the user satisfies a predetermined authentication policy without revealing either the user's credentials or the underlying policy predicate. In some examples, the authentication policy may require multiple signers, threshold conditions, or attribute-based conditions (e.g., age or geographic region).

To verify the user, the generated proof is provided to verification service 210, which uses the public verification key and the message to confirm that the proof is valid. Because the proof is non-interactive and succinct, verification can be performed efficiently and without requiring additional communication with client device 202.

In some examples, if the authentication policy has been updated, policy update service 216 may have previously issued an updated proving key and trapdoor to client device 202. Because the verification key is independent of the specific policy, verification service 210 remains unaware that an update occurred, thereby preserving policy privacy.

Upon successful verification by verification service 210, account service 204 recognizes the user account as authenticated. Third-party service 218 then grants access to the requested account or resource. In the case of a blockchain transaction, third-party service 218 may authorize execution of the transaction on-chain.

This example illustrates how the user of client device 202 can transact with third-party service 218 through a verified user account while benefiting from the privacy-preserving properties of zero-knowledge authenticator 206. Sensitive information such as credential structure, authentication logic, or policy updates are not exposed to third-party service 218 or to external observers, thereby improving security against targeted attacks and preserving user privacy.

In operation, client device 202 provides a request to account service 204, which in turn relies on zero-knowledge authenticator 206 to authenticate the user without revealing the underlying authentication policy or credentials. The modular architecture shown in FIG. 2 allows system 200 to support different variations of a zero-knowledge authenticator, including policy-private and obliviously updateable implementations, while maintaining compatibility with existing account and transaction services.

In another example, demonstrating the obliviously updateable property of OP-zkAt, policies can be replaced or augmented without disclosing to external parties that a change occurred. This capability allows administrators to securely rotate keys, revoke compromised credentials, or modify access rules without alerting adversaries or leaking organizational structure.

In this example, a user of client device 202 seeks access to a user account for transacting with or accessing third-party service 218 at a time when the authentication policy associated with the account has been updated. For instance, one of the authorized signers of a multi-signature policy may have lost their credential, and the account administrator has issued a new policy with a replacement signer.

Prior to the access request, an administrator interacts with policy update service 216 of zero-knowledge authenticator 206. Using a secret update key, policy update service 216 generates a new proving key and trapdoor corresponding to the updated policy, while leaving the public verification key unchanged. In some examples, policy update service 216 additionally signs an expiration time into the update, ensuring that the old policy can no longer be used after a defined period.

The updated proving key and trapdoor are securely delivered to client device 202. Because the verification key remains constant, no observable change is visible on-chain or to third-party service 218, and external observers cannot detect that the policy has been modified. The user of client device 202 can then provide a new access request to account service 206. This request includes a message, auxiliary data, and the updated proving key.

Account service 204 may communicate with proof service 208 to initiate generation of a zero-knowledge proof under the updated policy predicate. The proof demonstrates knowledge of valid credentials under the new policy without revealing the change or the contents of the credentials. Verification service 210 uses the same unchanged public verification key to validate the proof. Because the verification key is independent of the specific policy, verification service 210 is unable to distinguish whether the proof corresponds to the original policy or the updated policy. In some examples, account service 204 can be stored by third-party service 218 and be accessible to client device 202.

Upon successful verification, account service 204 authorizes the user's account such that third-party service 218 can execute the requested operation (e.g., allowing login, granting access to protected resources, or authorizing a blockchain transaction). From the perspective of third-party service 218, the authentication process is seamless and indistinguishable from a normal session.

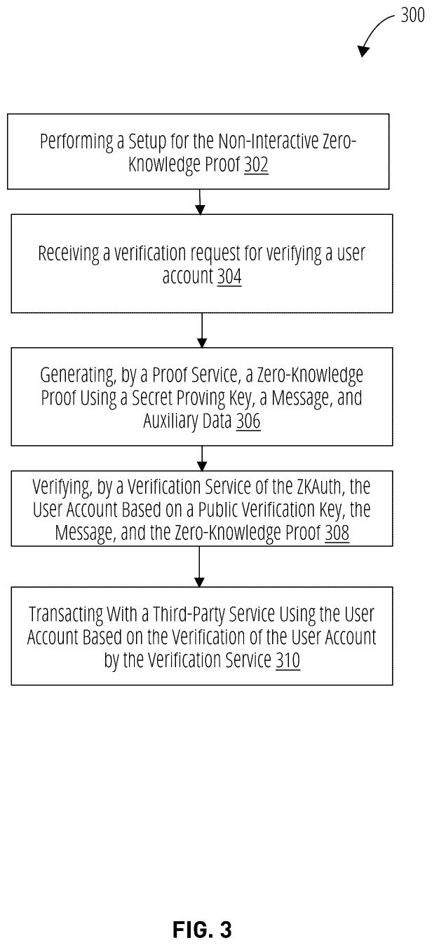

FIG. 3 illustrates an example method 300 for authenticating a user account with a third-party service using a zero-knowledge proof attesting that the user account was authenticated by a zkAt and that they have a true and valid identity in accordance with some aspects of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

As addressed in FIG. 1, in order to use some types of zero-knowledge proofs a setup process is used to establish the zero-knowledge proof and the common reference strings that will be shared between parties.

At block 302, method 300 can include performing a setup for the non-interactive zero-knowledge proof. For example, a setup service (e.g., setup service 212) may perform a setup for the non-interactive zero-knowledge proof. The setup provides the common reference string, including the prover parameters and verifier parameters as addressed in FIG. 1. In some examples, the setup service can receive a security parameter and an authentication policy and can output, using a setup algorithm, a public verification key, a secret proving key, and a secret trapdoor. In some examples, set up service 212 may reside on client device 202.

The secret proving key can facilitate updateability. For example, the proving key and verification key may be “decoupled,” where the proving key encodes policy-specific information, while the verification key remains generic. The secret proving key allows the user to produce valid proofs under both the original and updated policies. In other words, the secret proving key “moves” with the policy, while the verification key stays the same.

As introduced above, the present technology can use zk-SNARK as the zero-knowledge proof. There are several varieties of zk-SNARKs, and in some examples, the system (e.g., system 200) may use a type of zk-SNARK called a Groth16 protocol. Groth16 includes the one-time setup of a structured common reference string, which depends upon the specific circuit. In some examples, the setup is a trusted setup, which is easier for the prover 120, but the prover 120 could perform their own setup if they are capable. In some implementations of disclosed examples, a modified Groth16 protocol can be used, for example, to create a PP-zkAt. As an example, the PP-zkAt can hide the underlying policy. The PP-zkAt can have equivocable verification keys, which can ensure that the NIZK scheme is independent of its circuit. In some examples, trusted setup for Groth16 is not necessary.

At block 304, method 300 can include receiving a request for authorization of a user account of account service 204. For example, a user can request to log in to a user account hosted by third-party service 218.

At block 306, method 300 can include generating a zero-knowledge proof using the secret proving key, the message, and the auxiliary data. For example, a proof service (e.g., proof service 208) may generate a zero-knowledge proof using the secret proving key, the message, and the auxiliary data. As addressed above, the zero-knowledge proof can be a non-interactive zero-knowledge proof. The zero-knowledge proof can be generated based on the account service interacting with a proof service, which creates a zero-knowledge proof for a mathematical circuit that was setup at block 302 and an assertion to be proved. The mathematical circuit can be a standard mathematical circuit or a bespoke mathematical circuit.

In some examples, proof service 208 can recursively compose NIZK proofs with an inner proof and an outer proof. The inner proof can correspond to the policy predicate, while the outer proof corresponds to the knowledge of a valid proof to the policy predicate and to a signature on an inner verification key. In this example, zero-knowledge authenticator 206 can include a parameter generation service (e.g., parameter generation service 214) configured to receive a security parameter and output, using a parameter generation algorithm, a set of global parameters and a set of private parameters. In some examples, the outer verification key can remain constant such that updates are realized by issuing a new inner verification key and new signature. In some examples, setup service 213 of zero-knowledge authenticator 206 can generate an additional secret update key for use in executing a disjunctive policy update. In some examples, upon updating a policy, an expiration time can be included in the signature on the inner verification key to prevent reuse of an out-dated policy.

At block 308, method 300 can include verifying the user account by a verification service of the zero-knowledge authenticator based on a public verification key, the message, and the zero-knowledge proof. In some examples, the message can be bound into the proof (e.g., as a public input hashed inside the circuit or through a signature check).

At block 310, method 300 can include transacting with a third-party service using the user account based on the verification of the user account by the zero-knowledge authenticator. For example, account service 204 may transact with a third-party service using the user account based on the determination, by zero-knowledge authenticator 206, that the user account is verified. In some examples, e.g., when authorization is needed for a blockchain transaction, third-party service 218 can perform the transaction. In some examples, zero-knowledge authenticator 206 can output an indication to third-party service 218 or account service 204 that the user account has been authenticated such that the user account can be used to access or transact with third-party service 218.

In some examples, a user account can disjunctively update a policy using an OP-zkAt as referenced above. For example, a user can provide a policy update request to account service 204. Account service 204 can provide the policy update request to policy update service 216 of the zero-knowledge authenticator 206. The policy update request can include a disjunctive policy update, the secret proving key, and the policy update key. Using a policy update algorithm, the policy update service can generate an updated secret proving key and an updated trapdoor. Because the verification key is independent of policy updates, it remains unaltered, rendering inner policy changes undetectable.

Below is a description of an example implementation of a zero-knowledge authenticator for a family of authentication policies. As mentioned previously, a zkAt can capture low-level semantics of an authentication mechanism as a (polynomial-size) circuit.

Zero-Knowledge Authenticator (zkAt)

To define a zkAt, let Π={f:{0,1}^{poly(λ)}→{0, 1}} be a family of authentication policies, then a zero-knowledge authenticator for any policy P∈Π consists of the following polynomial time algorithms:
Setup Algorithm: Setup(1^{λ},P,τ)→(vk_{P}, pk_{P}, τ). The setup algorithm takes as input the security parameter A and the authentication policy P. It outputs a public verification key vk_{P}, a secret proving key pk_{P} (assuming that pk_{P} also implicitly contains P), and a secret trapdoor t.
Prove Algorithm: AuthProve (pkₚ, M, ω)→π or ⊥. The proving algorithm takes as input the secret key pkₚ, a message M∈ [symbol] to be signed and some auxiliary data ω∈Ω. It outputs a proof π or ⊥.
Verify Algorithm: Auth Vfy(vk_{P}, M, π)→{0,1}. The verification algorithm takes as input the
public verification key vk_{P}, a message M∈ [symbol] , and a proof π. It outputs 0 or 1.

A zero-knowledge authenticator must satisfy the following properties with respect to any policy P∈Π:
Completeness: For every message M∈ [symbol] and for every string ω∈Ω such that P(M∥ω)=1,

$$Pr [ AuthVfy ( {vk}_{P} , M , π ) = 1 : \begin{matrix}( {vk}_{P} , {pk}_{P} , τ ) ← \$ Setup ( {1}^{λ} , P ) \\ π ← \$ AuthProve ( {pk}_{P} , M , ω )\end{matrix} ] = 1$$

Knowledge soundness: There exists a PPT extractor ε such that for every For every PPT adversary [symbol] there is a negligible function ϵ(·) satisfying, for all λ∈ [symbol] ,

$$Pr [ \begin{matrix}AuthVfy ( {vk}_{P} , M * , π \text{*)} = 1 & & ( {vk}_{P} , {pk}_{P} , τ ) ← \$ Setup ( {1}^{λ} , P ) \\ & : & ( M * , π \text{*)} ← 𝒜 ( {vk}_{P} , {pk}_{P} ) \\ ∧ P ( M * \vert ω \text{*)} \neq 1 & & ω * ← ε ( τ , π \text{*)}\end{matrix} ] \leq ϵ ( λ )$$

Perfect data hiding: There exists a PPT simulator [symbol] such that for every PPT adversary [symbol] , every λ∈ [symbol] , every M∈ [symbol] and every string ω∈Ω such that P (M|ω)=11,

$$Pr [ \begin{matrix}𝒜 ( {vk}_{p} , M , π ) = 1 : \\ ( {vk}_{p} , {pk}_{p} , τ ) ← \$ Setup ( {1}^{λ} , P ) \\ π ← \$ AuthProve ( {pk}_{p} , M , ω )\end{matrix} ] = Pr [ \begin{matrix}𝒜 ( {vk}_{p} , M , π ) = 1 : \\ ( {vk}_{p} , {pk}_{p} , τ ) ← \$ Setup ( {1}^{λ} , P ) \\ π ← 𝒮 ( τ , M )\end{matrix} ]$$

In other words, these properties allow the construction of a zkAt authentication mechanism that lets a user prove they are authorized under some authentication policy without revealing the sensitive details of that policy or their credentials. Instead of just verifying a signature (like in traditional blockchain multisig or threshold schemes), here the authentication logic itself is encoded as a zero-knowledge proof.

zkAt can be constructed using a publicly-verifiable DP-NIZK scheme NIZK=(NIZK.Setup, NIZK.Prove, NIZK.Verify) for the relation [symbol] _{P}={(x, w):P(x∥w)=1}. The setup algorithm takes the security parameter λ and the policy P as input and runs the NIZK setup to obtain the verification and the prover keys, i.e., (vk_{zk}, pk_{zk}, τ)←$ NIZK.Setup(1^{λ},P). The setup algorithm then outputs a verification key, a proving key, and a trapdoor: vk_{P}:=vk_{zk}, pk_{P}: =pk_{zk} and τ, respectively.

The prove algorithm parses pk_{P} to obtain pk_{zk} and then computes the proof π←$ NIZK.Prove(pk_{zx}, x:=M, w:=w). The prove algorithm outputs the proof, which can act as a zero-knowledge signature of authorization.

The verify algorithm returns the output of NIZK.Verify (vk_{P}, M, π). In other words, the verify algorithm receives as input, the verification key, the message, and the proof, and outputs either 1 (accept) or 0 (reject).

Thus, the zkAt can be constructed by directly using a publicly verifiable DP-NIZK scheme. The setup algorithm runs the NIZK setup; the prove algorithm and the verify algorithm reuse NIZK.Prove and NIZK.Verify. Because of this, the security of zkAt reduces to the security of the underlying NIZK scheme such that the knowledge soundness of zkAt follows from the knowledge soundness of the NIZK and the perfect data hiding of zkAt follows from the zero-knowledge property of the NIZK.

As discussed above, the base zkAt hides the credentials of the user. However, there exists a second privacy issue: the authentication policy itself. If the verification key (vk) is tied to a specific policy, then simply publishing it leaks what policy is being used. Attackers can use this info to tailor attacks (e.g., target the weakest signer in a multisig).

### Policy-Private Zero-Knowledge Authenticator (PP-zkAt)

zkAt can be extended to hide the underlying policy by defining and using a new object called DP-NIZK schemes with equivocable verification keys. At a high level, the property of verification-key equivocation guarantees that the verification key of a DP-NIZK scheme is independent of its circuit. Normally, the verification key encodes the relation/circuit (here, the authentication policy). With equivocation, the verification key can be generated independently of the policy, meaning the same verification key could plausibly correspond to different policies, so an adversary cannot tell which one is actually in use.

Informally, the vk-equivocation game models an adversary who, given a verification key and a proof for a statement in languages specified by both circuits of its choice, must decide which of the said circuits does the key (and proof) correspond to. In other words, a vk-equivocation game can involve an adversary choosing two circuits (i.e., two policies). A challenger runs setup and gives the adversary a verification key and a proof corresponding to one of the two policies, and the adversary must guess which one is which. If the adversary can't distinguish better than random guessing, the scheme achieves equivocation.

More formally, a publicly verifiable DP-NIZK scheme has equivocable verification keys if for every stateful PPT adversary [symbol] , there is a negligible function ϵ(·) such that,

$$Pr [ \begin{matrix} & & \{ 0 , 1 \} ← \$ b \\ & & {C}_{0} , {C}_{1} ← 𝒜 ( {1}^{λ} ) \\ ∀ \hat{b} ∈ \{ 0 , 1 \} : {C}_{\hat{b}} ( x * \vert ω \text{*)} = 1 & : & ( {vk}_{b} , {pk}_{b} , {τ}_{b} ) ← \$ Setup ( {1}^{λ} , {C}_{b} ) \\ ∧ 𝒜 ( π ) = b & & ( x * , w \text{*)} ← 𝒜 ( {vk}_{b} ) \\ & & π ← \$ Prove ( {pk}_{b} , x * , w \text{*)}\end{matrix} ] \leq \frac{1}{2} + ϵ ( λ )$$

where each circuit C_{b} encodes an NP relation [symbol] _{b}={(x,w):C_{b}(x∥w)=1}.

Similarly to the vk-equivocation game for DP-NIZK, the corresponding policy-privacy game for zkAt can be defined with the circuits specifying the policies. Thus, a zkAt is said to be policy-private (PP-zkAt) if it additionally satisfies the following property:
Policy Privacy: For every stateful PPT adversary [symbol] , there is a negligible function ϵ(·) such that,

$$Pr [ \text{} \begin{matrix} & & \{ 0 , 1 \} ← \$ b \\ & & {P}_{0} , {P}_{1} ← 𝒜 ( {1}^{λ} ) \\ ∀ \hat{b} ∈ \{ 0 , 1 \} : {P}_{\hat{b}} ( M * \vert ω \text{*)} = 1 & : & ( {vk}_{Pb} , {pk}_{Pb} , {τ}_{b} ) ← \$ \\ & & Setup ( {1}^{λ} , {P}_{b} ) \\ ∧ 𝒜 ( π ) = b & & ( M * , ω \text{*)} ← 𝒜 ( {vk}_{Pb} ) \\ & & π ← \$ Auth Prove \\ & & ( {pk}_{Pb} , M * , ω \text{*)}\end{matrix} ] \text{} \leq \frac{1}{2} + ϵ ( λ )$$

A zkAt is policy-private if, in addition to completeness, soundness, and data hiding, it also satisfies policy privacy. This means that even with access to the verification key and proofs, an adversary cannot tell which policy is being enforced.

If the underlying DP-NIZK has equivocable verification keys and is zero-knowledge, then zkAt automatically becomes policy-private (PP-zkAt) as demonstrated in the below proof:

Proof. The proof proceeds through a sequence of hybrids.
H₀: This is the vk-equivocation experiment.
H₁: This is the same as hybrid H₀ except that instead of running Prove, the challenger runs the simulator [symbol] for NIZK without the witness to generate T.
   Notice that, by zero-knowledge of NIZK, hybrid H₁ is indistinguishable from hybrid H₀. vk_{P} can be shown to be independent of the choice of the policy. To show this, give a PPT reduction [symbol] _{Equiv} that, given a policy-privacy attacker [symbol] , breaks the vk-equivocation of NIZK with respect to hybrid H₁. In particular, [symbol] _{Equiv} does the following:
      On receiving policies P₀, P₁ from [symbol] , the reduction forwards them to the challenger [symbol] _{Equiv} and receives the corresponding verification key vk_{b} which it forwards as the vk_{Pb} to [symbol] .
      When [symbol] outputs (M*, ω*), the reduction forwards it to [symbol] _{Equiv} and receives a (simulated) proof π that it sends back to [symbol] .
      Finally, it outputs whatever A outputs.
   In doing so, [symbol] _{Equiv} wins with the same advantage as that of [symbol] . Thus, the zkAt must be policy-private.

Groth16 is a popular zkSNARK, and can be modified to support equivocable verification keys.

Groth16 normally ties vk to a specific relation. A compiler can modify the setup so that vk can be sampled independently. This achieves vk-equivocation while still retaining completeness, zero-knowledge, and knowledge soundness. Thus, in practice, PP-zkAt can be built from Groth16 with this modification.

Recall that the Groth's NIZK argument for QAPs (and therefore for any arithmetic circuit) which, looking ahead, encodes a split non-interactive linear proof (NILP) and thus allows for straightforward proof of security from that of the underlying split NILP.

For prime p such that |p|=λ, groups [symbol] ₁= [symbol] g₁ [symbol] and [symbol] ₂= [symbol] g₂ [symbol] and [symbol] _{T} such that the pairing e: [symbol] ₁× [symbol] ₂→ [symbol] _{T} is a bilinear map. Consider a QAP:

$$ℛ = \{ p , {𝔾}_{1} , {𝔾}_{2} , {𝔾}_{T} , e , {g}_{1} , {g}_{2} , ℓ {\{ {U}_{i} ( X ) , {V}_{i} ( X ) , {W}_{i} ( X ) \}}_{i = 0}^{m} , T ( X ) \} ,$$

that defines a field [symbol] ₚ and a language of statements

$$( {a}_{ℓ + 1} , ... , {a}_{m} ) ∈ {ℤ}_{p}^{m - ℓ}$$

and witnesses

$$( {a}_{1} , … , {a}_{ℓ} ) ∈ {ℤ}_{p}^{ℓ}$$

such that with a₀=1.

$${\sum }_{i = 0}^{m} {a}_{i} {U}_{i} ( X ) \cdot {\sum }_{i = 0}^{m} {a}_{i} {V}_{i} ( X ) - {\sum }_{i = 0}^{m} {a}_{i} {W}_{i} ( X ) = H ( X ) T ( X )$$

for some degree (n−2) polynomial H(X)∈ [symbol] ₚ[X].

Given this, the Groth16 NZIK argument is as follows:

The setup algorithm accepts the QAP [symbol] as input, sets the secret trapdoor

$$τ := ( α , β , γ , β , x ) for α , β , γ , β , x \text{←\$} {ℤ}_{p}^{*} ,$$

and outputs it along with the verifier key vk and the prover key pk where:

$$vk := ( \begin{matrix}{[ α ]}_{1} , {[ β ]}_{2} , {[ γ ]}_{2} , {[ δ ]}_{2} , \\ {\{ {Xi}_{1} := {[ \frac{β {U}_{i} ( x ) + α {V}_{i} ( x ) + {W}_{i} ( x )}{γ} ]}_{1} \}}_{i = 0}^{ℓ}\end{matrix} ) ,$$

$$p k := ( \begin{matrix}{[ α ]}_{1} , {[ β ]}_{1} , {[ β ]}_{2} , {[ δ ]}_{1} , {[ δ ]}_{2} , {\{ {[ {θ}_{j} ]}_{1} := {\frac{{x}^{j} T ( x )}{δ}}_{1} \}}_{j = 0}^{n ‐ 2} \\ {\{ {[ {ψ}_{i} ]}_{1} := {[ {U}_{i} ( x ) ]}_{1} \}}_{i = 0}^{m} , {\{ {[ {φ}_{i} ]}_{2} := {[ {V}_{i} [ x ] ]}_{2} \}}_{i = 0}^{m} \\ {\{ {[ {ζ}_{i} ]}_{1} := {[ \frac{β {U}_{i} ( x ) + α {V}_{i} ( x ) + {W}_{i} ( x )}{γ} ]}_{1} \}}_{i = ℓ + 1}\end{matrix} , )$$

The proving algorithm samples

$$r , s ← {ℤ}_{p}^{*}$$

and, using the instance and witness

$$( {a}_{1} , ... , {a}_{ℓ} , {a}_{ℓ + 1} , ... , {a}_{m} ) ∈ {ℤ}_{p}^{m} ,$$

sets the polynomial:

$$H ( X ) := \frac{{\sum }_{i = 0}^{m} {a}_{i} {U}_{i} ( X ) \cdot {\sum }_{i = 0}^{m} {a}_{i} {V}_{i} ( X ) - {\sum }_{i = 0}^{m} {a}_{i} {W}_{i} ( X )}{T ( X )}$$

It then computes

$$π := ( \begin{matrix}{[ A ]}_{1} := {[ α ]}_{i} + {r [ δ ]}_{1} + {\sum }_{i = 0}^{m} {{a}_{i} [ {ψ}_{i} ]}_{1} , {[ B ]}_{2} := {[ β ]}_{2} + {s [ δ ]}_{2} + {\sum }_{i = 0}^{m} {{a}_{i} [ {ψ}_{i} ]}_{2} , \\ {[ C ]}_{1} := {s [ α ]}_{1} + {r [ δ ]}_{1} + {rs [ δ ]}_{1} + {\sum }_{i = ℓ + 1}^{m} {{a}_{i} [ {ζ}_{i} ]}_{1} + {\sum }_{j = 0}^{n - 2} {{h}_{j} ( [ {θ}_{j} ] )}_{1}\end{matrix} )$$

given the pk, and outputs π as the proof.

Given the vk, the instance

$$( {a}_{1} , ... , {a}_{ℓ} ) ∈ {ℤ}_{p}^{ℓ}$$

and a proof π:=([A], [B], [C]), the verify algorithm simply checks whether

$${[ A ]}_{1} \cdot {[ B ]}_{2} {{=}^{?} [ α ]}_{1} \cdot {[ β ]}_{2} + {[ C ]}_{1} \cdot {[ δ ]}_{2} + ( {\sum }_{i = 0}^{ℓ} {{a}_{i} [ {X}_{i} ]}_{1} ) \cdot {[ γ ]}_{2}$$

and outputs the result.

An observation towards achieving policy-privacy is that the Groth16 verification key can be equivocated, in the sense that one can perform the Groth16 setup in a way that guarantees that vk can be sampled independently of the relation. A bootstrapping compiler can be given to build an equivocable Groth16 scheme given the non-equivocable version. To that end, consider the QAP [symbol] as described in:

$$ℛ = \{ p , {𝔾}_{1} , {𝔾}_{2} , {𝔾}_{T} , e , {g}_{1} , {g}_{2} , ℓ {\{ {U}_{i} ( X ) , {V}_{i} ( X ) , {W}_{i} ( X ) \}}_{i = 0}^{m} , T ( X ) \} ,$$

where

$$T ( X ) := {\prod }_{i = 1}^{n} ( X - {r}_{i} )$$

for all

$${r}_{i} ∈ {ℤ}_{p}^{*}$$

distinct, as in the standard QAP formulation. Now consider the following constructive procedure:
1. Sample

$$x , {y}_{U , 0} , {y}_{U , 1} , ... , {y}_{U , m} , {y}_{V , 0} , {y}_{V , 1} , ... , {y}_{V , m} , {y}_{W , 0} , {y}_{w , 1} , ... , {y}_{W , m} ← \$ {ℤ}_{p}^{*} .$$

2. For every symbol S∈{U, V, W} and for every i∈[0, m] interpolate the polynomial \tilde{S}ᵢ(X) [symbol] ₚ[X] over coordinates

Given this, the modified QAP

$$\tilde{ℛ} = \{ p , {𝔾}_{1} , {𝔾}_{2} , {𝔾}_{T} , e , {g}_{1} , {g}_{2} , ℓ {\{ {\tilde{U}}_{i} ( X ) , {\tilde{V}}_{i} ( X ) , {\tilde{W}}_{i} ( X ) \}}_{i = 0}^{m} , T ( X ) \}$$

defines the same relation as [symbol] .

More formally, T(X) divides

$${\sum }_{i = 0}^{m} {a}_{i} {\tilde{U}}_{i} ( X ) \cdot {\sum }_{i = 0}^{m} {a}_{i} {\tilde{V}}_{i} ( X ) - {\sum }_{i = 0}^{m} {a}_{i} {\tilde{W}}_{i} ( X )$$

if and only if (aᵢ, . . . , aₘ) is a satisfying assignment for [symbol] . This is proven as follows:

In the forward direction, notice that

$${Σ}_{i = 0}^{m} {a}_{i} {\tilde{U}}_{i} ( {r}_{j} ) \cdot {Σ}_{i = 0}^{m} {a}_{i} {\tilde{V}}_{i} ( {r}_{j} ) = {Σ}_{i = 0}^{m} {a}_{i} {\tilde{W}}_{i} ( {r}_{j} )$$

implies that

$$T ( X ) \vert {Σ}_{i = 0}^{m} {a}_{i} {\tilde{U}}_{i} ( X ) \cdot {Σ}_{i = 0}^{m} {a}_{i} {\tilde{V}}_{i} ( X ) - {Σ}_{i = 0}^{m} {a}_{i} {\tilde{W}}_{i} ( X )$$

for every j∈[n]. It follows that

$${a}_{j}^{L} o {a}_{j}^{R} = {a}_{j}^{O}$$

for all gates j. Thus, (aᵢ, . . . , aₘ) is a satisfying assignment for [symbol] .

In the reverse direction, notice that if (aᵢ, . . . , aₘ) is a satisfying assignment then for any gate j∈[n] it follows by construction that

$${\sum }_{i = o}^{m} {a}_{i} {\tilde{U}}_{i} ( {r}_{j} ) \cdot {\sum }_{i = o}^{m} {a}_{i} {\tilde{V}}_{i} ( {r}_{j} ) = {\sum }_{i = o}^{m} {a}_{i} {U}_{i} ( {r}_{j} ) \cdot {\sum }_{i = o}^{m} {a}_{i} {V}_{i} ( {r}_{j} ) = {\sum }_{i = o}^{m} {a}_{i} {W}_{i} ( {r}_{j} ) - {\sum }_{i = o}^{m} {a}_{i} {\tilde{W}}_{i} ( {r}_{j} ) .$$

So, having

$$( X - {r}_{j} ) \vert {\sum }_{i = 0}^{m} {a}_{i} {\tilde{U}}_{i} ( X ) \cdot {\sum }_{i = 0}^{m} {a}_{i} {\tilde{V}}_{i} ( X ) - {\sum }_{i = 0}^{m} {a}_{i} {\tilde{W}}_{i} ( X ) ,$$

the construction is general so this must hold for all j∈[n]. Consequently,

$$T ( X ) \vert {Σ}_{i = 0}^{m} {a}_{i} {\tilde{U}}_{i} ( X ) \cdot {Σ}_{i = 0}^{m} {a}_{i} {\tilde{V}}_{i} ( X ) - {Σ}_{i = 0}^{m} {a}_{i} {\tilde{W}}_{i} ( X ) .$$

The new setup algorithm is now defined as below.

The setup algorithm accepts a QAP [symbol] as explained by (1), sets the secret trapdoor τ:=(α, β, γ, δ, x, y_{U,0}, y_{U,1}, . . . , y_{U,m}, y_{V,0}, y_{V,1}, . . . , y_{V,m}, y_{W,0}, y_{W,1}, . . . , y_{W,m}) for all values in τ sampled uniformly from

$${ℤ}_{p}^{*} ,$$

and outputs it along with the verifier key vk and the prover key pk where,

$$vk := ( \begin{matrix}{[ α ]}_{1} , {[ β ]}_{2} , {[ γ ]}_{2} , {[ δ ]}_{2} , \\ {\{ {xi}_{1} := {[ \frac{β {y}_{U , i} + α {y}_{V , i} + {y}_{w , i}}{γ} ]}_{1} \}}_{i = 0}^{ℓ}\end{matrix} ) ,$$

$$pk := ( \begin{matrix}{[ α ]}_{1} , {[ β ]}_{1} , {[ β ]}_{2} , {[ δ ]}_{1} , {[ δ ]}_{2} , {\{ {[ {θ}_{j} ]}_{1} := {\frac{{x}^{j} T ( x )}{δ}}_{1} \}}_{j = 0}^{n - 2} \\ {\{ {[ {ψ}_{i} ]}_{1} := {[ {y}_{U , i} ]}_{1} \}}_{i = 0}^{m} , {\{ {[ {φ}_{i} ]}_{2} := {[ {y}_{V , i} ]}_{2} \}}_{i = 0}^{m} , \\ {\{ {[ {ζ}_{i} ]}_{1} := {[ \frac{β {y}_{U , i} + α {y}_{V , i} + {y}_{w , i}}{γ} ]}_{1} \}}_{i = ℓ + 1}\end{matrix} ) .$$

Notably, for instances of the same length, the verification key is independent of the relation. This leads to the following observation: The construction with respect to the modified setup algorithm described above satisfies vk-equivocation.

Proof. The proof proceeds through a sequence of hybrids.
H₀: This is the vk-equivocation experiment.
H₁: This is the same as hybrid H₀ except that instead of running Prove, the simulator [symbol] for NIZK can be run without the witness to generate π. By zero-knowledge of NIZK, hybrid H₁ is indistinguishable from hybrid H₀.
   Suppose b=0, then for every policy P∈Π and any fixed choice of (α, β, γ, δ, x) there exists a choice for y_{U,0}, y_{U,1} . . . , y_{U,m}, y_{V,0}, y_{V,1}, . . . , y_{V,m}>y_{W,0}, y_{W,1}, . . . , y_{W,m}) such that vk_{P}=vk_{Pb}. In other words, under the modified setup, the verification key information theoretically hides the underlying relation. Thus, in particular, there is a choice of y_{P,i}'s (symbol P∈{U, V, W}) such that vk_{P}_{₀}=vk_{P}_{₁}.

The construction with respect to the modified setup algorithm described above is knowledge sound. More precisely, it can be shown that it has statistical knowledge soundness against adversaries that only use a polynomial number of generic bilinear group operations.

Observing that the construction above is already a split NILP, only disclosure-freeness of the reference string (i.e., the discrete-log of pk and vk elements) needs to be shown as knowledge soundness would follow from the split NILP being disclosure free if for every adversary [symbol] and such that there is a negligible function ϵ(·) such that for every λ∈ [symbol] and every (x, w)∈ [symbol] ,

$$Pr [ {σ}_{1} \cdot T {σ}_{2} = 0 ⇔ {{σ}^{′}}_{1} \cdot T {{σ}^{′}}_{2} = 0 : \begin{matrix}T ← 𝒜 ( ℛ ) \\ ( {σ}_{1} , {σ}_{2} ) , ( {{σ}_{1}}^{′} , {{σ}^{′}}_{2} ) ← \$ Setup ( ℛ )\end{matrix} ] \geq 1 - ϵ ( λ )$$

Following the split-state NILP notation, the split reference string (σ₁, σ₂) is an evaluation of polynomials in α, β, etc. So, a test of the form σ₁·T_{σ}_{₂} for some adversarially chosen test matrix T evaluates to zero if either:
(i) It is a non-zero Laurent polynomial that evaluates to zero for the specific choice of input variables.
(ii) The formal multi-variate Laurent polynomial corresponding to the test is identically zero.

Recalling that the Schwartz-Zippel lemma states that a non-zero multivariate polynomial over [symbol] ₚ of total degree d evaluates to zero on a uniformly random point with probability at most d/(p−1). Thus, by the Schwartz-Zippel lemma it can be argued that, in the former case, the probability that for uniformly chosen evaluation points the non-zero polynomial evaluates to zero is negligible for polynomials of degree bounded by poly (γ). Moreover in the latter case σ₁ and σ₂ could be replaced by any other

$${σ}_{1}^{′} and {σ}_{2}^{′}$$

such that also

$${σ}_{1}^{′} \cdot T {σ}_{2}^{′} = 0 ,$$

which was to be shown.

In summary, PP-zkAt hides both credentials and the policy such that neither attackers nor observers know what authentication logic governs the account. This makes blockchain accounts much harder to profile since an observer cannot see if they use multisig, thresholds, or attribute-based conditions.

### Obliviously Updateable Policy-Private Zero-Knowledge Authenticator (OP-zkAt)

The following describes a way to update the underlying policy obliviously, i.e., given a pk_{P} with respect to an existing policy P∈Π, and a new policy P′∈Π, a construction that allows one to updat pk_{P} to

$$p {k}_{P}^{′}$$

without updating the corresponding vk_{P} can be provided. Thus, parties holding vk_{P} are oblivious to the amendment of the policy P. The below example is primarily concerned with disjunctive policy updates.

For a disjunctive policy update, let P∈Π be an existing policy. Then, an update P′∈Π is a disjunctive update if and only if P′ is a disjunction of P with some other valid policy. Thus, for each P∈Π, the predicate Admₚ(P′)=1⇔P′∈{P∨f:∀f∈Π}.

Barring the trivial idea of re-running the setup and distributing fresh keys under the new policy, obliviously performing general policy updates, which is to say non-disjunctive updates, appears to be somewhat challenging. This is because it would require a way to revoke a proving key under an older policy without also revoking the corresponding verification key. However, as explained below, allowing the older proving key to expire via a simple time-stamping procedure suffices for general policy updates (in a limited sense) with only minor generic modification to the overall construction.

An obliviously updateable PP-zkAt (OP-zkAt) additionally consists of the following polynomial time algorithms:
Gen(1^{λ})→(gp, pp). The parameter generation algorithm as input the security parameter λ, and outputs the (public) global parameters gp and the (secret) private parameters pp for the protocol. All algorithms of OP-ZK-Auth take gp as input, but it is omitted here for brevity. This algorithm is run once and for all.
Setup (1^{λ},P)→(vk_{P}, pk_{P}, κ, τ). The setup algorithm takes as input the security parameter λ and the authentication policy P. It outputs a public verification key vk_{P}, a secret proving key pk_{P}, a secret update key κ and a secret trapdoor τ.
PolUpdate

$$( p {k}_{P} , κ , {P}^{′} ) \to ( p {k}_{P}^{′} , {τ}^{′} )$$

or ⊥. The policy update algorithm takes as input the secret key pk_{P}, a secret update key κ and a disjunctive policy update P′. It outputs the updated secret proving key pk_{P} and the updated trapdoor τ′.

An OP-zkAt must additionally satisfy the following properties for policies P, P′∈Π,
Update completeness: For every message M∈ [symbol] and for every string ω∈Ω such that (P′M∥ω)=1, then

$$Pr [ \begin{matrix}( gp , pp ) ← \$ Gen ( {1}^{λ} ) \\ AuthVfy ( {vk}_{P} , M , π ) = 1 : \begin{matrix}{vk}_{P} , {pk}_{P} , κ , τ ) ← \$ Setup ( {1}^{λ} , P ) \\ ( {pk}_{P}^{′} , {τ}^{′} ) ← \$ PolUpdate ( {pk}_{p} , τ , {P}^{′} )\end{matrix} \\ π ← \$ AuthProve ( {pk}_{P} , M , ω )\end{matrix} ] = 1$$

Update knowledge soundness: There exists a PPT extractor ε such that for every For every PPT adversary [symbol] there is a negligible function ϵ(·) satisfying, for all λ∈ [symbol] ,

$$Pr [ \begin{matrix}( gp , pp ) ← Gen ( {1}^{λ} ) \\ P ← 𝒜 ( gp ) \\ \begin{matrix}AuthVfy ( {vk}_{P} , {M}^{*} , {π}^{*} ) = 1 ∧ \\ ∀ {P}^{′} ∈ {Q}_{P} : {P}^{′} ( {M}^{*} ‖ {ω}^{*} ) \neq 1\end{matrix} : ( {vk}_{P} , {pk}_{P} , κ , τ ) ← \$ Setup ( {1}^{λ} , P ) \\ ( {M}^{*} , {π}^{*} ) ← {𝒜}^{{𝒪}_{κ}} ( gp , {vk}_{P} , {pk}_{P} ) \\ {ω}^{*} ← ε ( pp , τ , {π}^{*} )\end{matrix} ] = \leq ∈ ( {1}^{λ} )$$

where the oracle [symbol] _{κ}(·) takes as input a disjunctive policy update P⁽ⁱ⁾∈Π in its i^{th}-query. It adds P⁽ⁱ⁾ to the set Q_{P}⊇{P} and outputs the signing key

$$p {k}_{P}^{( i )}$$

under P⁽ⁱ⁾ by running PolUpdate(pk_{P}, κ, P⁽ⁱ⁾) and stores the corresponding secret trapdoor τ⁽ⁱ⁾.

Since the verification key vk_{P} is independent of the policy updates, the view of the policy privacy adversary remains unaltered from that for a PP-zkAt.

The construction below for an OP-zkAt utilizes a signature scheme SIG=(SIG.Setup, SIG.Sign, SIG.Verify), an inner NIZKAoK scheme NIZK_{I}=(NIZK_{I}.Setup, NIZK_{I}.Prove, NIZK_{I}.Verify) and a general-purpose outer NIZKAoK scheme, NIZK_{O}=(NIZK_{O}.Setup, NIZK_{O}.Prove, NIZK_{O}.Verify) for the following relation

$${ℛ}_{O} = \{ \begin{matrix}x := ( {vk}_{σ} , M ) & : & {NIZK}_{I} . Verify ( {crs}_{I} , M , {π}_{I} ) & = 1 \\ w := ( {crs}_{I} , {π}_{I} , σ ) & & ∧ SIG . Verify ( {vk}_{σ} , {crs}_{I} , σ ) & = 1\end{matrix} \}$$

Gen(1^{λ})→(gp, pp). Given the security parameter λ as input, the parameter generation algorithm generates the NIZK crs as (crs_{O}, τ_{O})←$ NIZK_{O}.Setup(1^{λ}) and outputs gp:=crs_{O} and pp:=τ_{O}. This algorithm is run once and for all.
Setup (1^{λ},P)→(vk_{P}, pk_{P}, κ, τ). Given the security parameter λ and the policy P as input, the setup algorithm runs the inner NIZK setup to obtain (crs_{I}, τ_{I})←$ NIZK_{I}.Setup(1^{λ},P). Next, it creates the signing and verification keys for the signature scheme as (vk_{σ}, sk_{σ})←$ SIG.Setup(1^{λ}), and then signs crs_{I} to obtain σ←$ SIG.Sign(sk_{σ}, crs_{I}). Finally, it outputs vk_{P}:=vk_{σ}, pk_{P}:=(crs_{I}, vk_{σ}, σ), κ:=sk, and τ:=τ_{I}.
AuthProve(pk_{P}, M, ω)→π or ⊥. It first parses pk_{P} as (crs_{I}, vk_{σ}, σ) and continues only if SIG.Verify (vk_{σ}, crs_{I}, σ)=1, otherwise it aborts and outputs ⊥. It then computes the proof π_{I}←$ NIZK_{I}.Prove(crs_{I}, x:=M, w:=w) and then outputs the final proof π computed as π←$ NIZK_{O}.Prove(gp, x:=(vk_{σ}, M), w:=(crs_{I}, π_{I}, σ)).
AuthVfy (vk_{P}, M, τ)→{0, 1}. It returns the output of NIZK_{O}.Verify(gp, x:=(vk_{P}, M), π).
PolUpdate

$$( {pk}_{P} , κ , {P}^{′} ) \to ( {pk}_{P}^{i} , {τ}^{i} )$$

or ⊥. If Adm(P′)≠1, it outputs ⊥ and aborts. Otherwise, it parses pk_{P} as (pk_{I}, vk_{I}, vk_{σ}, σ). Then, the update algorithm re-runs the inner NIZK setup with this input to obtain

$$( {crs}_{I}^{′} , {τ}_{1}^{′} ) \text{←\$} {NIZK}_{.}$$

Setup(1^{λ},P′). Next, it signs

$${crs}_{I}^{′}$$

to obtain

$${σ}^{′} \text{←\$} SIG . Sign ( κ , {crs}_{I}^{′} ) .$$

Finally, it outputs

$${pk}_{P}^{i} := ( {crs}_{I}^{′} , {vk}_{σ} , {σ}^{′} ) and {τ}^{′} := {τ}_{I}^{′} .$$

Assuming NIZK schemes NIZK_{I} and NIZK_{O} are knowledge sound, and the signature scheme SIG is existentially unforgeable under chosen messages, the OP-zkAt construction is update knowledge sound for disjunctive updates as shown below:

It can be shown that extractor ε is able to extract a valid witness with non-negligible probability. In particular, on input pp, τ and π*, the extractor ε does the following:
It uses the secret private parameters pp to extract a witness from π* as

$$( {crs}_{I}^{*} , {π}_{I}^{*} , {σ}^{*} ) ← {ℰ}_{O} ( pp , {π}^{*} ) .$$

Next, if

$${crs}_{I}^{*} = {crs}_{I}^{( i )}$$

for some i∈[0, |Q_{P}|], it uses the corresponding secret trapdoor τ⁽ⁱ⁾ to extract a witness from

$${π}_{I}^{*}$$

as

$${ω}^{*} ← {ℰ}_{I} ( {τ}^{( i )} , {π}_{I}^{*} )$$

and outputs it.

Let v(λ) be the probability,

$$Pr [ ∀ i ∈ [ 0 , \vert {Q}_{P} \vert ] : {crs}_{I}^{*} \neq {crs}_{I}^{( i )} ] .$$

Also let

$${Adv}_{KSnd , 𝒜}^{O} ( λ )$$

be an adversary's advantage in the NIZKAoK knowledge soundness experiment for NIZK_{O} (similarly, for NIZKᵢ). Then, the probability that & extracts successfully is

$$( 1 - {Adv}_{KSnd , 𝒜}^{O} ( λ ) ) \cdot ( 1 - {Adv}_{KSnd , 𝒜}^{I} ( λ ) ) \cdot ( 1 - v ( λ ) ) .$$

Which is at least (1−ϵ(λ)), for some negligible function ϵ(·) if v(λ) is negligible. Now suppose, for contradiction, that v(λ) is non-negligible then one can provide a PPT reduction [symbol] _{EUnf} that, given [symbol] , breaks the existential unforgeability of SIG (under chosen messages). In particular, [symbol] _{EUnf} does the following:
On receiving the policy P from [symbol] , the reduction runs the setup honestly, except that instead of signing the crs_{I} by itself, it the EUnf challenger [symbol] _{EUnf} for the signature σ.
On the i^{th} update query, it runs the policy update algorithm honestly, except that instead of signing the

$${crs}_{I}^{( i )}$$

by itself, it the EUnf challenger [symbol] _{EUnf} for the signature σ⁽ⁱ⁾.
Finally, when [symbol] outputs (M*, π*), the reduction uses the secret trapdoor to extract a witness from π* as

$$( {crs}_{I}^{*} , {π}_{I}^{*} , {σ}^{*} ) ← {ℰ}_{O} ( pp , {π}^{*} )$$

and outputs

$$( {crs}_{I}^{*} , {σ}^{*} )$$

as its forgery.

Since, by assumption,

$${crs}_{I}^{*} \neq {crs}_{I}^{( i )}$$

for any i∈[0,|Q_{P}|], it follows that

$$( {crs}_{I}^{*} , {σ}^{*} )$$

is a valid forgery. Thus, [symbol] _{EUnf} wins with probability

$$( ( 1 - {Adv}_{KSnd , 𝒜}^{O} ( λ ) ) ) \cdot v ( λ ) .$$

It therefore follows that v(λ) is negligible, and consequently, the construction of OP-zkAt is update knowledge sound for disjunctive updates.

Perfect data hiding-Assuming the NIZK scheme NIZK_{I} has perfect zero-knowledge, the construction of OP-zkAt is perfectly data hiding.

Proof. The proof proceeds through a sequence of hybrids.
H₀: This is the real perfect data hiding experiment for OP-zkAt.
H₁: This is the same as hybrid H₀ except that instead of running AuthProve as is, the challenger first runs the simulator [symbol] _{I} for NIZK, without w to generate π_{I}, and then proceed as before.

Notice that hybrid H₁ is just the simulated perfect data hiding experiment for OP-zkAt. By perfect zero-knowledge of NIZK_{I}, hybrid H₁ is perfectly indistinguishable from hybrid H₀, and consequently, this construction is perfectly data hiding.

Policy privacy—Assuming the NIZK scheme NIZK_{O} has computational zero-knowledge, the construction of OP-zkAt is policy private.

Proof. The proof proceeds through a sequence of hybrids.
H₀: This is the real perfect data hiding experiment for OP-zkAt.
H₁: This is the same as hybrid H₀ except that instead of running AuthProve, the challenger runs the simulator [symbol] _{O} for NIZK_{O} without the witness to generate π.

By computational zero-knowledge of NIZK_{O}, hybrid H₁ is computationally indistinguishable from hybrid H₀. Furthermore, notice that vk_{P} is independent of the choice of the policy. It therefore follows that this construction of OP-zkAt is policy private.

A generic modification to the above construction allows one to perform general policy-updates obliviously.

The outer NIZKAoK scheme, NIZK_{O}=(NIZK_{O}.Setup, NIZK_{O}.Prove, NIZK_{O}.Verify) for the following relation

$${ℛ}_{O} = \{ \begin{matrix}x := ( {vk}_{σ} , M , {t}_{cur} ) & : & {NIZK}_{I} . Verify ( {crs}_{I} , M , {π}_{I} ) = 1 ∧ {t}_{exp} > {t}_{cur} \\ w := ( {crs}_{I} , {π}_{I} , {t}_{exp} , σ ) & & ∧ SIG . Verify ( {vk}_{σ} , {crs}_{I} \vert \vert {t}_{exp} , σ ) = 1\end{matrix} \}$$

Setup (1^{λ}, (P, tₑₓₚ))→(vk_{P}, pk_{P}, κ, τ). Given the security parameter λ, the policy P and a timestamp tₑₓₚ as input, the setup algorithm runs the inner NIZK setup to obtain (crs_{I}, τ_{I})←$ NIZK_{I}.Setup(1^{λ},P). Next, it creates the signing and verification keys for the signature scheme as (vk_{σ}, sk_{σ})←$ SIG.Setup(1^{λ}), and then signs crs_{I} to obtain σ←$ SIG.Sign(sk_{σ}, crs_{I}∥tₑₓₚ). Finally, it outputs vk_{P}: =vk_{σ}, pk_{P}:=(crsp_{I}, vk_{σ}, tₑₓₚ, σ), κ:=sk_{σ} and τ:=τ_{I}.
AuthProve (pkₚ, (M, t_{cur}), ω)→π or ⊥. It first parses pkₚ as (crs_{I}, vk_{σ}, σ) and continues only if SIG.Verify (vk_{σ}, crs_{I},σ)=1, otherwise it aborts and outputs ⊥. It then computes the proof π_{I}<$ NIZK_{I}.Prove(crs_{I}, x:=M, w:=w) and then outputs the final proof π computed as π←$ NIZK_{O}.Prove(gp,x:=(vk_{σ}, M, t_{cur}), w:=(crsp_{I}, π_{I}, tₑₓₚ, σ)).
AuthVfy

$$( {vk}_{P} , ( M , {t}_{cur}^{′} , {t}_{cur} , ℰ ) π ) \to \{ 0 , 1 \} .$$

### If

$$\vert {t}_{cur} - {t}_{cur}^{′} \vert \geq ℰ$$

then it outputs 0. Otherwise, it returns the output of

$${NIZK}_{O} . Verify ( gp , x := ( {vk}_{P} , M , {t}_{cur}^{′} ) , π ) .$$

PolUpdate

$$( {pk}_{P} , κ , ( {P}^{′} , {t}_{exp}^{′} ) ) \to ( {pk}_{P}^{′} , {τ}^{′} )$$

or ⊥. If Adm_{P}(P′)≠1, it outputs ⊥ and aborts. Otherwise, it parses pkₚ as (pk_{I}, vk_{I}, vk_{σ}, σ). Then, the update algorithm re-runs the inner NIZK setup with this input to obtain

$$( {crs}_{I}^{′} , {τ}_{I}^{′} ) \text{←\$} {NIZK}_{I} .$$

Setup(1^{λ},P′). Next, it signs

$${crs}_{I}^{′}$$

to obtain

$${σ}^{′} \text{←\$} SIG . Sign ( κ , {crs}_{I}^{′} \vert \vert {t}_{exp}^{′} ) .$$

Finally, it outputs

$$pk := ( {crs}_{I}^{′} , {vk}_{σ} , {t}_{exp}^{′} , {σ}^{′} ) and {τ}^{′} := {τ}_{I}^{′} .$$

This construction does not preclude the situation where an old proving key is still usable before it has expired. However, this may be acceptable, and even desirable, in many practical situations where, for instance, an authority may want to allow the provers some time before transitioning to a new policy.

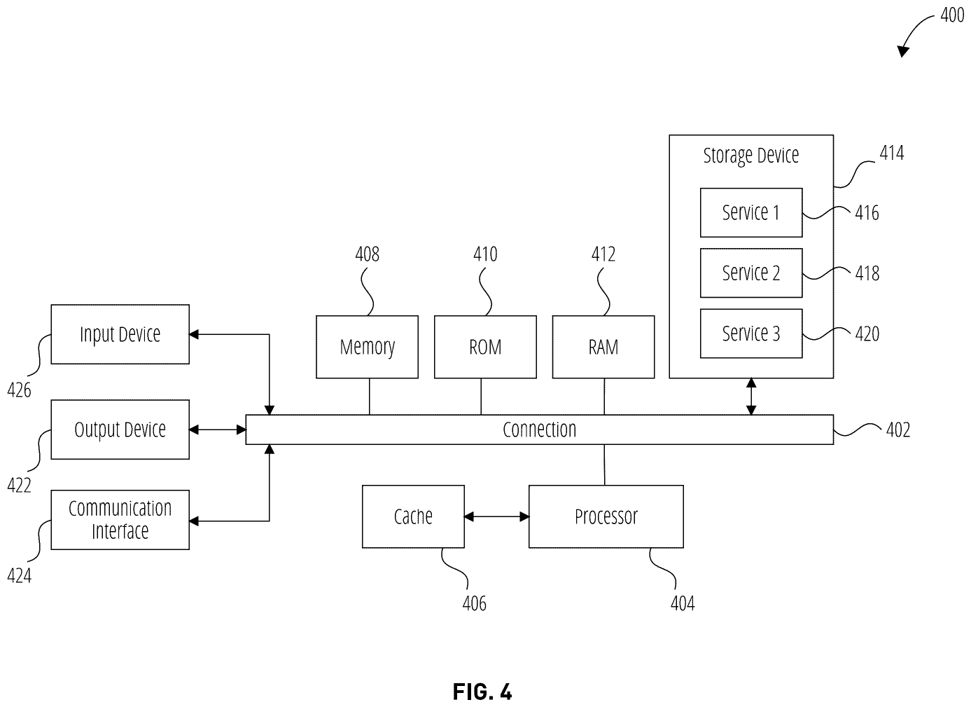

FIG. 4 shows an example of computing system 400, which can be for example any computing device making up the account service, or any component thereof in which the components of the system are in communication with each other using connection 402. Connection 402 can be a physical connection via a bus, or a direct connection into processor 404, such as in a chipset architecture. Connection 402 can also be a virtual connection, networked connection, or logical connection.

In some examples, computing system 400 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example computing system 400 includes at least one processing unit (CPU or processor) 404 and connection 402 that couples various system components including system memory 408, such as read-only memory (ROM) 410 and random access memory (RAM) 412 to processor 404. Computing system 400 can include a cache of high-speed memory 406 connected directly with, in close proximity to, or integrated as part of processor 404.

Processor 404 can include any general purpose processor and a hardware service or software service, such as services 416, 418, and 420 stored in storage device 414, configured to control processor 404 as well as a special-purpose processor where software instructions are incorporated into the actual processor design. Processor 404 may essentially be a completely self-contained computing system, containing multiple cores or processors, a bus, memory controller, cache, etc. A multi-core processor may be symmetric or asymmetric.

To enable user interaction, computing system 400 includes an input device 426, which can represent any number of input mechanisms, such as a microphone for speech, a touch-sensitive screen for gesture or graphical input, keyboard, mouse, motion input, speech, etc. Computing system 400 can also include output device 422, which can be one or more of a number of output mechanisms known to those of skill in the art. In some instances, multimodal systems can enable a user to provide multiple types of input/output to communicate with computing system 400. Computing system 400 can include communication interface 424, which can generally govern and manage the user input and system output. There is no restriction on operating on any particular hardware arrangement, and therefore the basic features here may easily be substituted for improved hardware or firmware arrangements as they are developed.

Storage device 414 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 414 can include software services, servers, services, etc., that when the code that defines such software is executed by the processor 404, it causes the system to perform a function. In some examples, a hardware service that performs a particular function can include the software component stored in a computer-readable medium in connection with the necessary hardware components, such as processor 404, connection 402, output device 422, etc., to carry out the function.

For clarity of explanation, in some instances the present technology may be presented as including individual functional blocks including functional blocks comprising devices, device components, steps or routines in a method embodied in software, or combinations of hardware and software.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Some aspects of the present technology include:

Aspect 1: A method of using a zero-knowledge authenticator to anonymously authenticate a user account, the method comprising: receiving, by a verification service of a zero-knowledge authenticator, a verification request for verifying a user account, the verification request being received from an account service stored on a client device, the verification request comprising a zero-knowledge proof, a public verification key, and a message, and wherein the zero-knowledge proof is generated by a proof services of the client device based on a secret proving key, the message, and auxiliary data; verifying, by the verification service of a zero-knowledge authenticator, the user account based on a public verification key, the message, and the zero-knowledge proof; and transacting, by the account service with a third-party service, using the user account based on the verification of the user account by the verification service.

Aspect 2: The method of Aspect 1, wherein the zero-knowledge authenticator is a policy-private zero-knowledge authenticator using equivocable verification keys.

Aspect 3: The method of any of Aspects 1-2, further comprising: generating the equivocable verification keys using a set-up algorithm to build an equivocable scheme that does not reveal information about the policy.

Aspect 4: The method of any of Aspects 1-3, wherein the zero-knowledge authenticator comprises a setup service and wherein the method further comprises: receiving, by the setup service, a security parameter and a policy; and generating, by the setup service, a public verification key, the secret proving key, and a secret trapdoor.

Aspect 5: The method of any of Aspects 1-4, the method further comprising: enabling a disjunctive policy update by generating, at a parameter generation service of the zero-knowledge authenticator, a set of global parameters and a set of private parameters based on the security parameter.

Aspect 6: The method of any of Aspects 1-5, the method further comprising:
outputting, by the setup service, a secret update key.

Aspect 7: The method of any of Aspects 1-6, the method further comprising: receiving, at a policy update service of the zero-knowledge authenticator, the secret proving key, the secret update key, and a disjunctive policy update; and updating the policy, by the policy update service, by generating an updated secret proving key and an updated trapdoor.

Aspect 8: The method of any of Aspects 1-7, wherein the public verification key is independent of the disjunctive policy update and remains unaltered.

Aspect 9: The method of any of Aspects 1-8, wherein the zero-knowledge proof comprises a recursive composition of proofs.

Aspect 10: The method of any of Aspects 1-9, wherein the method further comprises: generating, by the proof service, an inner proof corresponding to a policy predicate and an outer proof corresponding to knowledge of a valid inner proof and to a signature on an inner verification key.

Aspect 11: The method of any of Aspects 1-10, wherein the inner verification key can be changed with no change to an outer verification key, such that the verification service is unaware of the change to the inner verification key.

Aspect 12: The method of any of Aspects 1-11, wherein the signature on the inner verification key comprises an expiration time.

Aspect 13: A non-transitory computer-readable medium having stored thereon instructions that, when executed by at least one processor, cause the at least one processor to perform operations according to any of Aspects 1-12.

Aspect 14: A computing system for performing a function, comprising one or more means for performing operations according to any of Aspects 1-12.

What is claimed is:

1. A method of using a zero-knowledge authenticator to anonymously authenticate a user account, the method comprising:
receiving, by a verification service of a zero-knowledge authenticator, a verification request for verifying a user account, the verification request being received from an account service stored on a client device, the verification request comprising a zero-knowledge proof, a public verification key, and a message, and wherein the zero-knowledge proof is generated by a proof services of the client device based on a policy, and on a secret proving key, the message, and auxiliary data;
verifying, by the verification service of a zero-knowledge authenticator, the user account based on a public verification key, the message, and the zero-knowledge proof; and
transacting, by the account service with a third-party service, using the user account based on the verification of the user account by the verification service.

2. The method of claim 1, wherein the zero-knowledge authenticator is a policy-private zero-knowledge authenticator using equivocable verification keys.

3. The method of claim 2, further comprising:
generating the equivocable verification keys using a set-up algorithm to build an equivocable scheme that does not reveal information about the policy.

4. The method of claim 1, wherein the zero-knowledge authenticator comprises a setup service and wherein the method further comprises:
receiving, by the setup service, a security parameter and a policy; and
generating, by the setup service, a public verification key, the secret proving key, and a secret trapdoor.

5. The method of claim 4, the method further comprising:
enabling a disjunctive policy update by generating, at a parameter generation service of the zero-knowledge authenticator, a set of global parameters and a set of private parameters based on the security parameter.

6. The method of claim 5, the method further comprising:
outputting, by the setup service, a secret update key.

7. The method of claim 6, the method further comprising:
receiving, at a policy update service of the zero-knowledge authenticator, the secret proving key, the secret update key, and a disjunctive policy update; and
updating the policy, by the policy update service, by generating an updated secret proving key and an updated trapdoor.

8. The method of claim 7, wherein the public verification key is independent of the disjunctive policy update and remains unaltered.

9. The method of claim 1 wherein the zero-knowledge proof comprises a recursive composition of proofs.

10. The method of claim 1, wherein the zero-knowledge proof comprises: an inner proof corresponding to a policy predicate and an outer proof corresponding to knowledge of a valid inner proof and to a signature on an inner verification key.

11. The method of claim 10, wherein the inner verification key can be changed with no change to an outer verification key, such that the verification service is unaware of the change to the inner verification key.

12. A computing system comprising:
at least one processor; and
a memory storing instructions that, when executed by the processor, configure the computing system to:
receive a verification request for verifying a user account, the verification request being received from an account service stored on a client device, the verification request comprising a zero-knowledge proof, a public verification key, and a message, and wherein the zero-knowledge proof is generated by a proof services of the client device based on a policy, and on a secret proving key, the message, and auxiliary data;
verify, by a verification service, the user account based on a public verification key, the message, and the zero-knowledge proof; and
output, by the verification service to a client device, an indication of successful verification of the user account to allow the user account to transact with a third-party service.

13. The computing system of claim 12, wherein the instructions further configure the computing system to:
receive, by a setup service, a security parameter and the policy; and
generate, by the setup service, a public verification key, the secret proving key, and a secret trapdoor.

14. The computing system of claim 13, wherein the instructions further configure the computing system to:
enable a disjunctive policy update by generating, at a parameter generation service, a set of global parameters and a set of private parameters based on the security parameter.

15. The computing system of claim 14, wherein the instructions further configure the computing system to:
output, by the setup service, a secret update key.

16. The computing system of claim 15, wherein the instructions further configure the computing system to:
receive, at a policy update service, the secret proving key, the secret update key, and a disjunctive policy update; and
update the policy, by the policy update service, by generating an updated secret proving key and an updated trapdoor.

17. The computing system of claim 16, wherein the public verification key is independent of the disjunctive policy update and remains unaltered.

18. The computing system of claim 12, wherein the instructions further configure the computing system to:
receive, from a proof service of the client device, an inner proof corresponding to a policy predicate and an outer proof corresponding to knowledge of a valid inner proof and to a signature on an inner verification key.

19. The computing system of claim 18, wherein the inner verification key can be changed with no change to an outer verification key, such that the verification service is unaware of the change to the inner verification key.

20. A non-transitory computer-readable storage medium comprising instructions stored thereon that when executed by at least one processor, cause the at least one processor to:
receive a verification request for verifying a user account, the verification request being received from an account service stored on a client device, the verification request comprising a zero-knowledge proof, a public verification key, and a message, and wherein the zero-knowledge proof is generated by a proof services of the client device based on a policy, and on a secret proving key, the message, and auxiliary data;
verify, by a verification service, the user account based on a public verification key, the message, and the zero-knowledge proof; and
output, by the verification service to a client device, an indication of successful verification of the user account to allow the user account to transact with a third-party service.
